(19) United States
(12) Patent Application Publication
(10) Pub. No.: US 2008/0128386 A1
(43) Pub. Date: Jun. 5, 2008

(54) METHOD OF MANUFACTURING INKJET PRINTHEAD

(75) Inventors: Yong-seop YOON, Seoul (KR); Hyung Choi, Seongnam-si (KR); Moon-chul Lee, Yongin-si (KR); Yong-won Jeong, Seoul (KR); Dong-sik Shim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/838,347

(22) Filed: Aug. 14, 2007

(30) Foreign Application Priority Data
Dec. 4, 2006 (KR) 2006-121791

(51) Int. Cl. G11B 5/127

(52) U.S. Cl. 216/27

(57) ABSTRACT

A method of manufacturing an inkjet printhead includes forming an insulating layer, heaters, and electrodes sequentially on a substrate, depositing a chamber layer having a plurality of ink chambers on the insulating layer, forming an ink feed hole in the substrate and the insulating layer to supply ink to the ink chambers, preparing a nozzle layer having a plurality of nozzles and an adhesive layer formed on a lower surface of the nozzle layer, and bonding the nozzle layer to the chamber layer.

### CROSS-REFERENCE TO RELATED APPLICATIONS

This application claims the benefit of Korean Patent Application No. 10-2006-0121791, filed on Dec. 4, 2006, in the Korean Intellectual Property Office, the disclosure of which is incorporated herein in its entirety by reference.

### BACKGROUND OF THE INVENTION

1. Field of the Invention

The present general inventive concept relates to a method of manufacturing an inkjet printhead, and more particularly, to a method of manufacturing an inkjet printhead with a reduced cost, a simplified process, and an improved productivity.

2. Description of the Related Art

In general, inkjet printheads form images by ejecting fine droplets of ink onto print media. The inkjet printheads can be classified into two types according to an ink droplet ejecting mechanism: thermal inkjet printheads and piezoelectric inkjet printheads. The thermal inkjet printheads generate bubbles in ink by using heat and eject the ink utilizing the expansion of the bubbles, and the piezoelectric inkjet printheads eject the ink by using a pressure generated by a deformation of a piezoelectric material.

The ink droplet ejecting mechanism of the thermal inkjet printhead will now be described in more detail. When a current pulse flows through a heater formed of a resistive heating material, the heater generates heat, and thus the ink adjacent to the heater is heated instantly to a temperature of about 300° C. Accordingly, bubbles are generated in ink and as the bubbles expand to increase the pressure to be applied to the ink filled in an ink chamber. Therefore, the ink is ejected out of the ink chamber through nozzles in the shape of droplets.

FIG. 1 is a schematic cross-sectional view illustrating a conventional thermal inkjet printhead. Referring to FIG. 1, the conventional inkjet printhead includes a substrate 10 on which a plurality of material layers are formed, a chamber layer 20 stacked on the substrate 20, and a nozzle layer 30 stacked on the chamber layer 20. A plurality of ink chambers 22 are formed in the chamber layer 20 to contain ink to be ejected. The nozzle layer 30 includes a plurality of nozzles 32, through which the ink is ejected. An ink feed hole 11 for supplying the ink to the ink chambers 22 is formed in the substrate 10. A plurality of restrictors 24 connecting the ink chambers 11 to the ink feed hole 11 are formed in the chamber layer 20.

An insulating layer 12 for insulating the substrate 10 from a plurality of heaters 14 is formed on the substrate 10. In addition, the heaters 14 for heating the ink and generating bubbles are formed on the insulating layer 12. Electrodes 16 are formed on the heaters 14. A passivation layer 18 is formed on the surfaces of the heaters 14 and the electrodes 16 for protecting them, and anti-cavitation layers 19 are formed on the passivation layer 18 to protect the heaters 14 from a cavitation force generated when the bubbles collapse.

FIGS. 2 through 5 illustrate a method of manufacturing the conventional inkjet printhead of FIG. 1. Referring to FIGS. 1 and 2, the insulating layer 12 is formed on the substrate 10, and the heaters 14 and the electrodes 16 are sequentially formed on the insulating layer 12. The protective layer 18 is formed on the insulating layer 12 to cover the heaters 14 and the electrodes 16, and the anti-cavitation layers 19 are formed on the passivation layer 18. Then, a trench 13 exposing the surface of the substrate 10 is formed by patterning the passivation layer 18 and the insulating layer 12. Next, referring to FIG. 3, a predetermined material is applied to the structure of FIG. 2 and then patterned to form the chamber layer 20 to define the ink chambers (22 of FIG. 1) and the restrictors 24. A sacrificial layer 25 is formed to fill the ink chambers 22 and the restrictors 24, and an upper surface of the sacrificial layer 25 is planarized by chemical mechanical polishing (CMP) process. Referring to FIG. 4, a predetermined material is applied to the upper surfaces of the sacrificial layer 25 and the chamber layer 20 and patterned to form the nozzle layer 30 having the nozzles 32. Referring to FIG. 5, a rear surface of the substrate 10 is etched until the sacrificial layer 25 is exposed to form the ink feed hole 11. The sacrificial layer 25 exposed through the ink feed hole 11 and the nozzles 32 is removed to form the ink chambers 22 and the restrictors 24.

However, the above method of manufacturing the inkjet printhead requires many processes, such as a filling-up process of the sacrificial layer 25, the CMP process of the sacrificial layer 25, and a removal process of the sacrificial layer 25, which make the manufacturing process complex and expensive. In addition, it is difficult to form the chamber layer 20 to a precise thickness by CMP, and thus the uniformity of the process is degraded. Also, it takes a lot of time to remove the sacrificial layer 25, and impurities may be introduced into the inkjet printhead while removing the sacrificial layer 25. Meanwhile, the ink feed hole 11 may be formed to penetrate substrate 10 formed of silicon wafer by dry etching. However, an etching speed and uniformity of the dry etching vary as each portions of the wafer, and thus the uniformity of the shape of the ink feed holes is degraded. This makes flow characteristics of the ink uneven, degrading the performance of the inkjet printhead and reducing manufacturing productivity.

### SUMMARY OF THE INVENTION

The present general inventive concept provides a method of manufacturing an inkjet printhead, which can reduce manufacturing costs and improve productivity by simplifying a manufacture process of the inkjet printhead.

Additional aspects and utilities of the present general inventive concept will be set forth in part in the description which follows and, in part, will be obvious from the description, or may be learned by practice of the general inventive concept.

The foregoing and/or other aspects of the present general inventive concept may be achieved by providing a method of manufacturing an inkjet printhead, the method including forming an insulating layer, heaters, and electrodes sequentially on a substrate, depositing a chamber layer having a plurality of ink chambers on the insulating layer, forming an ink feed hole in the substrate and the insulating layer to supply ink, preparing a nozzle layer having a plurality of nozzles and an adhesive layer formed on a lower surface of the nozzle layer, and bonding the nozzle layer to the chamber layer.

The nozzle layer may be bonded to the chamber layer by adhering bonding between the adhesive layer and an upper surface of the chamber layer.

The ink feed hole may be formed through the substrate and the insulating layer by laser machining.

The preparing of the nozzle layer may include preparing a nozzle plate, forming the adhesive layer on the lower surface of the nozzle plate, patterning the adhesive layer, and etching the nozzle plate exposed by the patterned adhesive layer to form the nozzle layer having the plurality of nozzles.

The nozzle plate may be formed of a silicon wafer or a glass substrate. The chamber layer may further include a plurality of restrictors that connect the ink feed hole to the ink chambers.

The method may further include forming a passivation layer on the heaters and the electrodes to cover the heaters and the electrodes, after forming the heaters and the electrodes. The method may further include forming anti-cavitation layers on the passivation layer that is located on the heaters, after forming the passivation layer.

The foregoing and/or other aspects of the present general inventive concept may also be achieved by providing a method of manufacturing an inkjet printhead, the method including forming an insulating layer, heaters, and electrodes sequentially on a substrate, depositing a chamber layer having a plurality of ink chambers on the insulating layer, forming an ink feed hole for supplying ink, in the substrate and the insulating layer, preparing a nozzle plate that is formed of a transparent material and includes an adhesive layer formed on a lower surface of the nozzle plate, bonding the nozzle plate to the chamber layer, patterning the adhesive layer, and forming a nozzle layer having a plurality of nozzles by etching the nozzle plate exposed by the patterned adhesive layer.

The nozzle plate may be formed of a glass substrate.

The patterning of the adhesive layer may include: preparing a photo mask, on which nozzle patterns are formed, on an upper portion of the nozzle plate; exposing the adhesive layer through the photo mask; and developing the exposed adhesive layer.

The foregoing and/or other aspects of the present general inventive concept may also be achieved by providing a method of manufacturing an inkjet printhead, the method including forming an insulating layer, heaters, and electrodes sequentially on a substrate, depositing a chamber layer having a plurality of ink chambers on the insulating layer, forming an ink feed hole in the substrate and the insulating layer to supply ink, preparing a nozzle plate including an adhesive layer having a shape corresponding to an upper surface of the chamber layer on a lower surface of the nozzle plate; bonding the nozzle plate to the chamber layer, and forming a nozzle layer having a plurality of nozzles by patterning the nozzle plate.

The nozzle plate may be formed of a silicon wafer or a glass substrate.

The forming of the nozzle layer may include applying a photoresist to an upper surface of the nozzle plate; patterning the photoresist, and etching the nozzle plate exposed through the patterned photoresist to form a plurality of nozzles.

The foregoing and/or other aspects of the present general inventive concept may also be achieved by providing a method of manufacturing an inkjet printhead, the method including forming an insulating layer, heaters, and electrodes sequentially on a substrate, forming a chamber layer on the insulating layer to define a plurality of ink chambers, forming an ink feed hole in the substrate and the insulating layer to supply ink to the ink chambers, and bonding a nozzle layer to the chamber layer to through the adhesive layer.

The ink feed hole may be formed before the bonding the nozzle layer to the chamber layer.

The bonding of the nozzle layer to the chamber layer may include forming an adhesive layer on between the nozzle layer and the chamber layer, and attaching the bonding layer to the chamber layer.

The bonding of the nozzle layer to the chamber layer may include forming a plurality of nozzles to correspond to the respective ink chambers in the nozzle layer before or after the bonding of the nozzle layer to the chamber layer.

The bonding of the nozzle layer to the chamber layer may include forming an adhesive layer on between the nozzle layer and the chamber layer, and attaching the bonding layer to the chamber layer, forming regions to correspond to nozzles on the adhesive layer, and forming the nozzles to correspond to the respective ink chambers on the nozzle layer through the regions of the adhesive layer before or after the bonding of the nozzle layer to the chamber layer.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic cross-sectional view illustrating a conventional inkjet printhead;

FIGS. 2 through 5 are cross-sectional views illustrating a method of manufacturing the inkjet printhead of FIG. 1;

FIGS. 6 through 11 are cross-sectional views illustrating a method of manufacturing an inkjet printhead according to an embodiment of the present general inventive concept;

FIGS. 12 through 17 are cross-sectional views illustrating a method of manufacturing an inkjet printhead according to another embodiment of the present general inventive concept; and

FIGS. 18 through 22 are cross-sectional views illustrating a method of manufacturing an inkjet printhead according to another embodiment of the present general inventive concept.

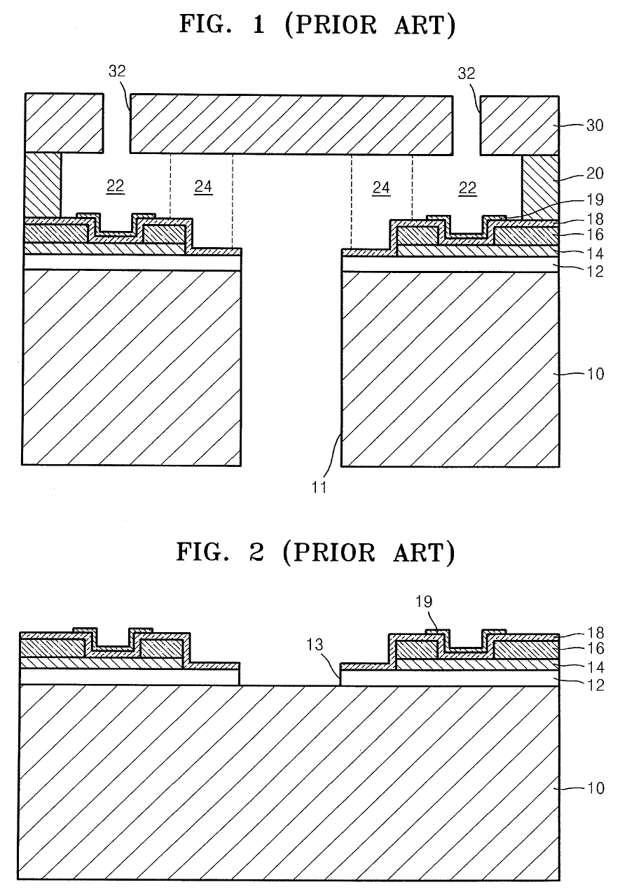

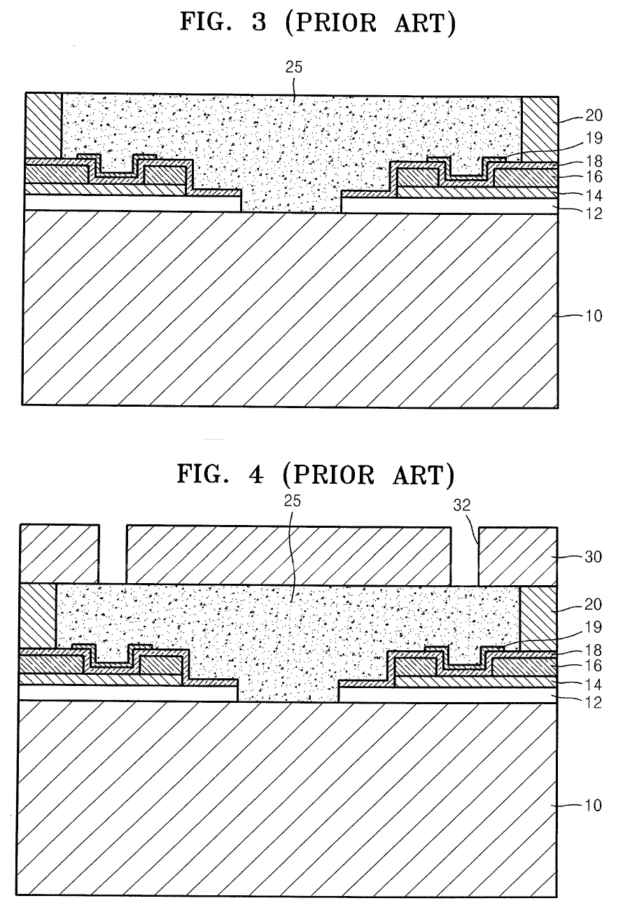

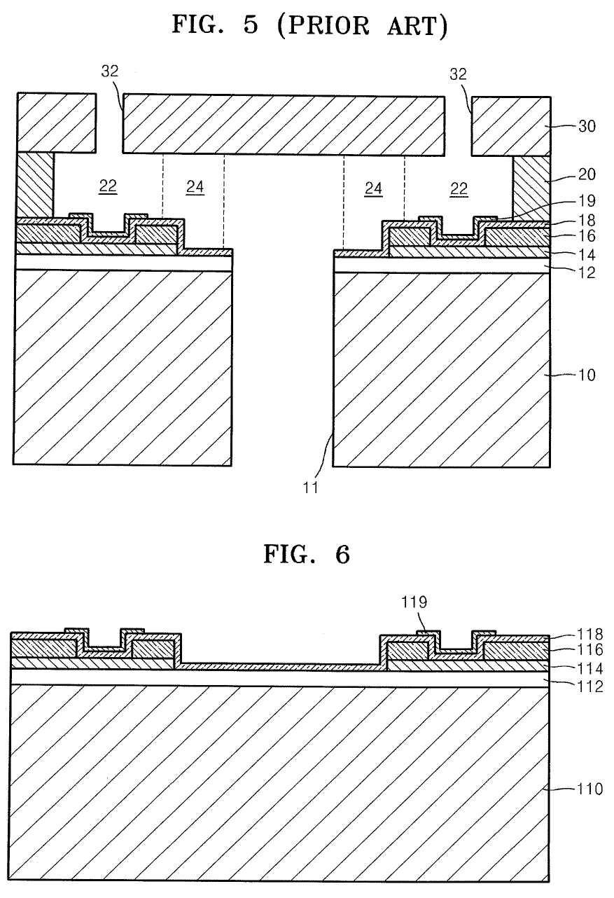

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIGS. 6 through 11 are cross-sectional views illustrating a method of manufacturing an inkjet printhead according to an embodiment of the present general inventive concept.

Referring to FIG. 6, a substrate 110 is prepared, and an insulating layer 112 is formed on an upper surface of the substrate 110. A silicon wafer is usually used as the substrate 110, but the present general inventive concept is not limited thereto. The insulating layer 112 insulates heaters 114 formed thereon from the substrate 110, and can be formed of, for example, silicon oxide. The insulating layer 112 can be formed by oxidizing the upper surface of the substrate 110. The heaters 114 for heating the ink to generate bubbles are formed on the insulating layer 112. The heaters 114 can be formed by depositing a heating resistive material, for example, an alloy of tantalum-aluminum, tantalum nitride, titanium nitride, or tungsten silicide, on the insulating layer 112 or the oxidized surface of the substrate 110, and patterning the deposited material. In addition, electrodes 116 are formed on the heaters 114 to supply an electric current to the heaters 114. The electrodes 116 can be formed by depositing a metal having a high electrical conductivity, for example, aluminum, aluminum alloy, gold, or silver, on the heaters 114, and patterning the deposited metal.

Next, a passivation layer 118 can be further formed on the insulating layer 112 to cover the heaters 114 and the electrodes 116. The passivation layer 118 prevents the heaters 114 and the electrodes 116 from being oxidized or corroded by contact with the ink, and can be formed of silicon oxide or silicon nitride. Anti-cavitation layers 119 can be further formed on the upper surface of the passivation layer 118 that becomes a bottom of ink chambers (122 of FIG. 11). The anti-cavitation layers 119 protect the heaters 114 from a cavitation force generated when the bubbles collapse, and can be formed of Ta.

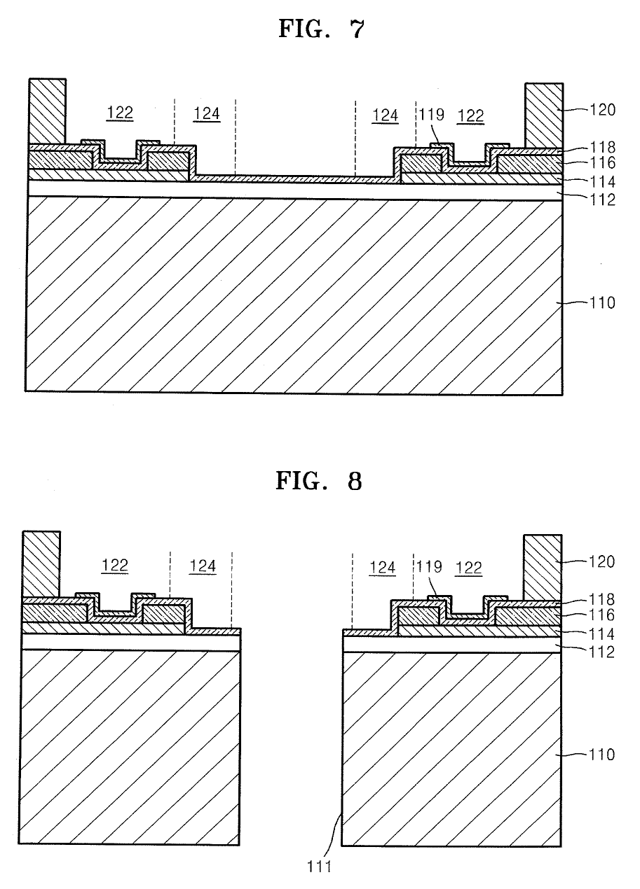

Referring to FIG. 7, a chamber layer 120 is formed on the passivation layer 118 to define the ink chambers 122 to contain the ink to be ejected. The chamber layer 120 can be formed by depositing a chamber material layer to cover the structure of FIG. 6, and patterning the deposited material layer. Accordingly, the ink chambers 122 can be formed on upper portions of the heaters 114 to contain the ink to be ejected. The chamber layer 120 can be formed of the same material as an adhesive layer (135 of FIG. 11) that will be described later, for example, a photoresist. However, the present general inventive concept is not limited thereto. Meanwhile, restrictors 124, that are passages connecting the ink chambers 122 to an ink feed hole 111 that will be described later, can be further formed on the chamber layer 120 as a passage to connect the ink chambers 122 to the ink feed hole 111.

Referring to FIG. 8, the ink feed hole 111 is formed in the substrate 110, the insulating layer 112, and the passivation layer 118 to supply the ink to the ink chambers 122. The ink feed hole 111 can be formed by penetrating the substrate 110, the insulating layer 112, and the passivation layer 118 using a laser machining process. A predetermined portion of the substrate 110 can be processed precisely by the laser, so that the ink feed hole 111 can have a uniform shape. In addition, when the ink feed hole 111 is formed using the laser machining process, conventional photolithography and etching processes are not required, and thus a manufacturing process can be simplified. In addition, since an upper portion of the chamber layer 120 is not covered by an element, such as a nozzle plate, but open, the structure of the inkjet printhead is not damaged even when the laser penetrates the substrate 110, the insulating layer 112, and the passivation layer 118 to form the ink feed hole 111.

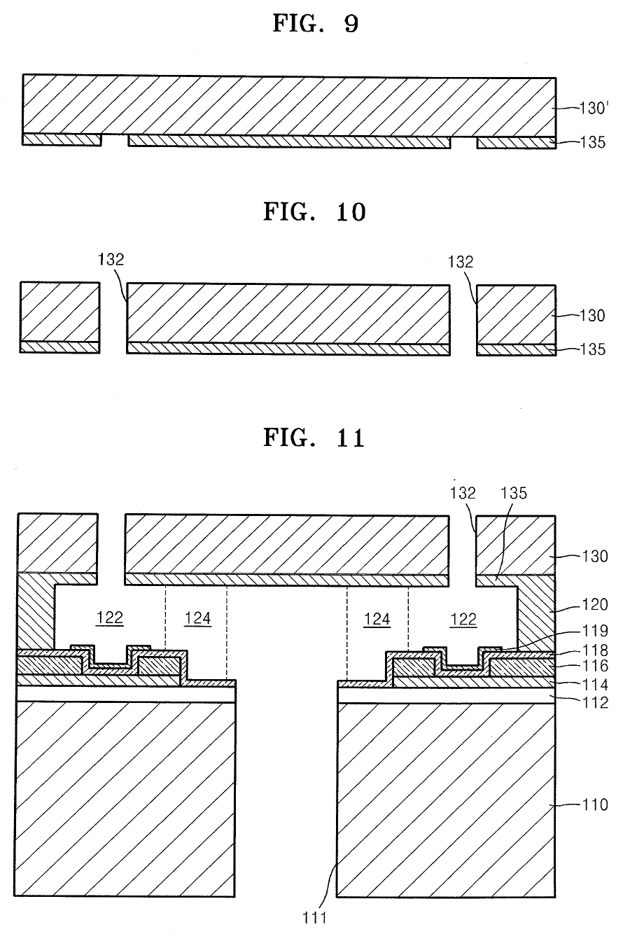

Referring to FIG. 9, a nozzle plate 130′ is prepared. A silicon wafer or a glass substrate can be used as the nozzle plate 130′, but the present general inventive concept is not limited thereto. The nozzle plate 130′ can be manufactured by processing the silicon wafer or the glass substrate to have the same thickness as a nozzle layer (130 of FIG. 11) that will be described later. The silicon wafer or the glass substrate can be processed by a dry etching, wet etching, or polishing process. Next, the adhesive layer 135 is formed of a photosensitive material is formed on the lower surface of the nozzle plate 130′ to form the adhesive layer 135 to be patterned. The photosensitive material can be a photoresist. Regions of the nozzle plate 130′ to correspond to nozzles are exposed through the patterned adhesive layer 135. Referring to FIG. 10, the regions of the nozzle plate 130′ exposed by the patterned adhesive layer 135 is etched to form the nozzle layer 130 having a plurality of nozzles 132.

Referring to FIG. 11, the nozzle layer 130 of FIG. 10 is bonded onto the chamber layer 120 of FIG. 8 to complete the inkjet printhead of the current embodiment. The nozzle layer 130 and the chamber layer 120 can be bonded to each other by adhesive bonding between the adhesive layer 135 and the upper surface of the chamber layer 120. In this case, the adhesive layer 135 formed on the lower portion of the nozzle layer 130 is attached to the upper surface of the chamber layer 120, and heat and pressure are applied thereto to bond the nozzle layer 130 to the chamber layer 120.

The nozzle plate 130′ and the nozzle layer 130 can be interchangeably used as a plate or layer attached to the chamber layer 120 to define the ink chambers 122 with the chamber layer 120. so that the ink flows from the feed hole 111 to the nozzles 132 through the corresponding ink chambers 122. The adhesive layer 135 may be formed on the lower surface of the nozzle plate 130′ to be attached to the chamber layer 120, and the nozzles 132 can be formed before or after attaching the nozzle plate 130′ to the chamber layer 120.

As described above, according to the method of manufacturing the inkjet printhead of the current embodiment, the chamber layer 120 and the nozzle layer are fabricated separately and then bonded together. Therefore, a sacrificial layer filling process, a CMP process of the sacrificial layer, and a removal process of the sacrificial layer according to the conventional manufacturing process of the conventional inkjet printhead are not necessary, and thus a manufacturing process of the inkjet printhead can be simplified. Accordingly, a manufacturing cost of the inkjet printhead can be reduced, and productivity can be improved. In addition, the nozzle layer of the conventional art is formed of a polymer, but the nozzle layer 130 of the current embodiment is formed of the silicon wafer or glass substrate, and thus damage on the nozzle layer 130 can be prevented and a robust inkjet printhead can be manufactured. Also, since the ink feed hole 111 is formed by the laser machining process, the ink feed hole 111 can be easily fabricated with a constant or uniform shape without damaging the structure of the inkjet printhead.

FIGS. 12 through 17 are cross-sectional views illustrating a method of manufacturing an inkjet printhead according to another embodiment of the present general inventive concept.

The manufacturing processes illustrated in FIGS. 6 through 8 can also be applied to the current embodiment, and thus detailed descriptions of those processes are omitted here. FIG. 12 may be the same as FIG. 8, and reference numerals 210, 211 212, 214, 216, 218 and 219 respectively denote a substrate, an ink feed hole, an insulating layer, heaters, electrodes, a passivation layer, and anti-cavitation layers. The ink feed hole 211 can be formed by penetrating the substrate 210, the insulating layer 212, and the passivation layer 218 using a laser machining process as described above. Reference numeral 220 denotes a chamber layer having ink chambers 222 and restrictors 224. The chamber layer 220 can be formed of the same material as an adhesive layer (235 of FIG. 14) that will be described later, for example, photoresist, but the present general inventive concept is not limited thereto.

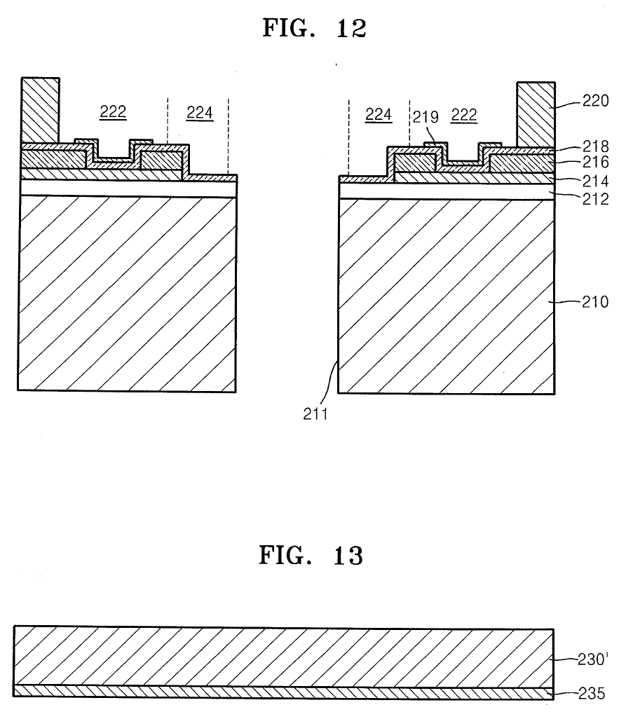

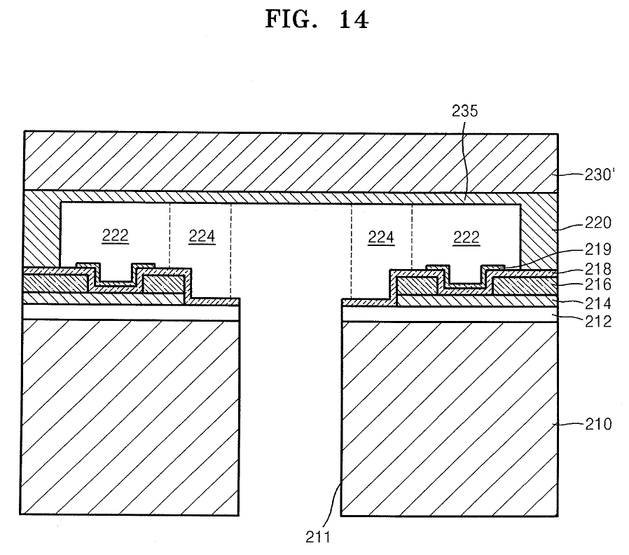

Referring to FIG. 13, a nozzle plate 230′ formed of a transparent material is prepared. A glass substrate can be used as the nozzle plate 230′, but the present invention is not limited thereto. The nozzle plate 230′ can be formed by processing the glass substrate to the same thickness as a nozzle layer (230 of FIG. 17) that will be described later. The glass substrate can be processed by a dry etching, wet-etching, or polishing process. Otherwise, the nozzle plate 230′ can be processed to the same thickness as the nozzle layer 230 after bonding with the chamber layer 220. The adhesive layer 235 formed of the photosensitive material is formed on a lower surface of the nozzle plate 230′. Here, the photosensitive material can be the photoresist.

Referring to FIG. 14, the nozzle plate 230′ of FIG. 13 is bonded to the chamber layer 220 of FIG. 12. The nozzle plate 230′ and the chamber layer 220 can be bonded to each other by adhesive bonding between the adhesive layer 235 and the upper surface of the chamber layer 220. That is, the adhesive layer 235 formed on the lower surface of the nozzle plate 230′ is attached to the upper surface of the chamber layer 220, and heat and pressure are applied thereto, to bond the nozzle plate 230′ to the chamber layer 220.

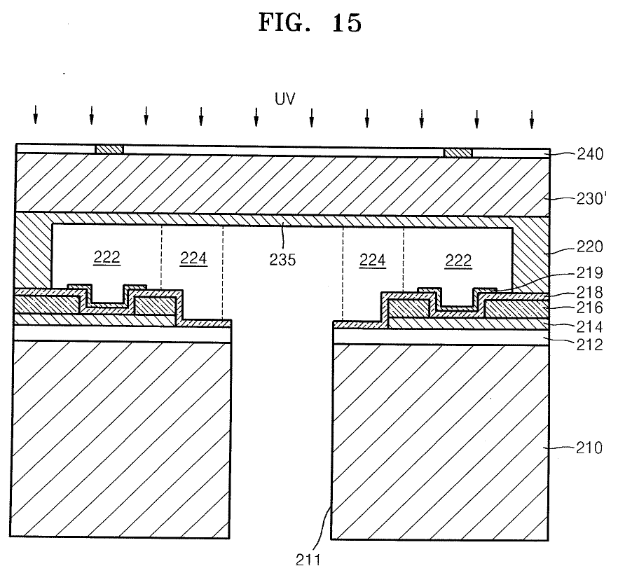

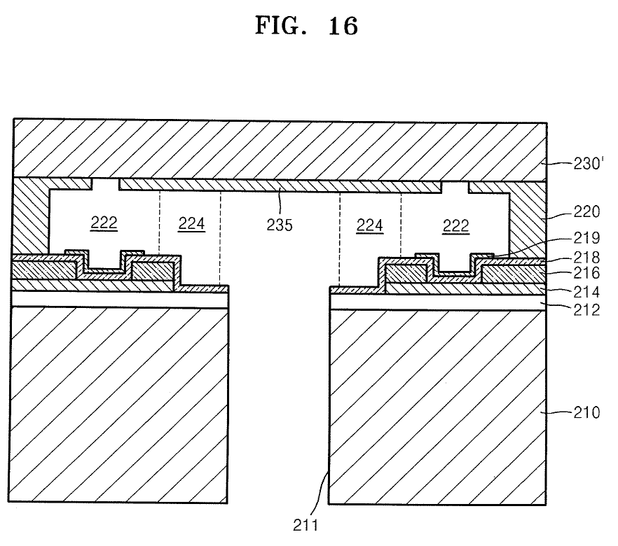

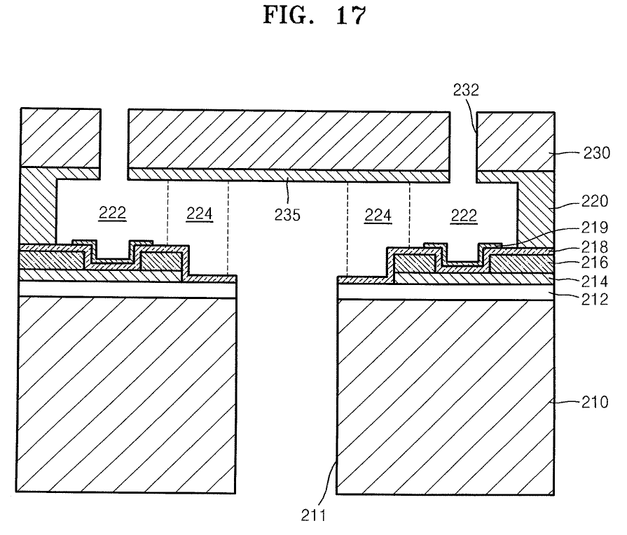

Referring to FIG. 15, the adhesive layer 235 formed on the lower surface of the nozzle plate 230′ is patterned. A photo mask 240 having nozzle patterns is positioned on an upper portion of the nozzle plate 230′, and then ultraviolet rays are irradiated onto the adhesive layer 235 through the photo mask 240 and the transparent nozzle plate 230′. Referring to FIG. 16, when the adhesive layer 235 is developed, regions on the nozzle plate 230′, on which the nozzles are formed, are exposed by the patterned adhesive layer 235. In addition, the nozzle plate 230′ exposed by the patterned adhesive layer 235 is etched to form the nozzle layer 230 having a plurality of nozzles 232 as illustrated in FIG. 17.

FIGS. 18 through 22 are cross-sectional views illustrating a method of manufacturing an inkjet printhead according to another embodiment of the present general inventive concept.

The processes illustrated in FIGS. 6 through 8 can be applied in the current embodiment, and thus their detailed descriptions are omitted here. FIG. 18 is the same as FIG. 8, and reference numerals 310, 311, 312, 314, 316, 318, and 319 respectively denote a substrate, an ink feed hole, an insulating layer, heaters, electrodes, a passivation layer, and anti-cavitation layers. The ink feed hole 311 can be formed by penetrating the substrate 310, the insulating layer 312, and the passivation layer 318 using a laser machining process. In addition, reference numeral 320 denotes a chamber layer including ink chambers 322 and restrictors 324.

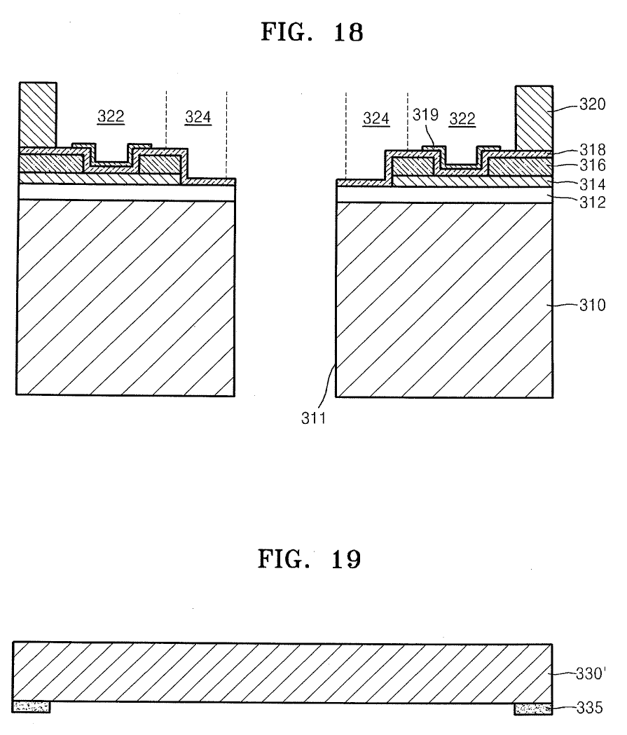

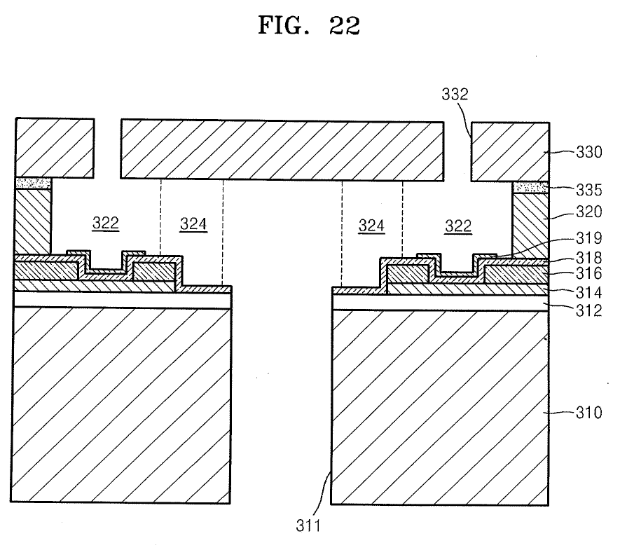

Referring to FIG. 19, a nozzle plate 330′ is prepared. The silicon wafer or the glass substrate can be used as the nozzle plate 330′, but the present general inventive concept is not limited thereto. The nozzle plate 330′ can be formed to the same thickness as a nozzle layer (330 of FIG. 22) that will be described later by processing the silicon wafer or the glass substrate. Otherwise, the nozzle plate 330′ can be formed to the same thickness as the nozzle layer 330 after being bonded to the chamber layer 320. Next, an adhesive layer 335 formed of a photosensitive material is formed on the lower surface of the nozzle plate 330′ to correspond to the chamber layer 320. The adhesive layer 335 can have the same shape as the upper surface of the chamber layer 320. The adhesive layer 335 can be formed by depositing an adhesive material layer on the lower surface of the nozzle plate 330′ and patterning the adhesive material layer. The adhesive layer 335 can be formed of a photosensitive material such as photoresist or adhesive.

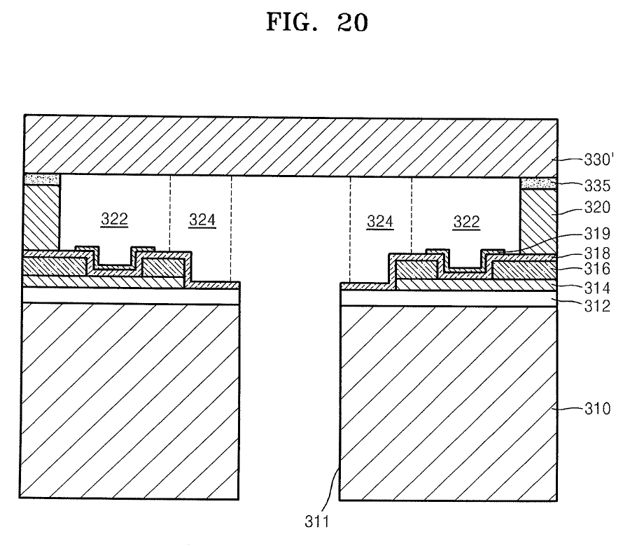

Referring to FIG. 20, the nozzle plate 330′ of FIG. 19 is bonded to the chamber layer 320 of FIG. 18. The nozzle plate 330′ can be bonded to the chamber layer 320 by adhering bonding between the adhesive layer 325 and the upper surface of the chamber layer 320. That is, the adhesive layer 325 formed on the lower surface of the nozzle plate 330′ is attached to the upper surface of the chamber layer 320, and heat and pressure are applied thereto to bond the nozzle plate 330′ onto the chamber layer 320.

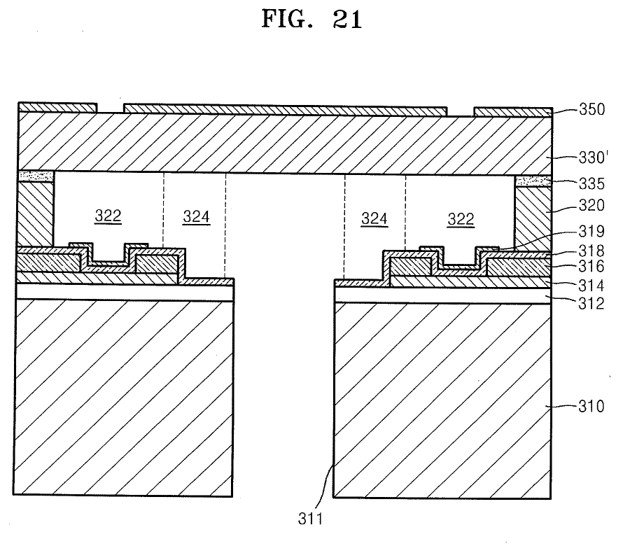

Next, the nozzle plate 330′ is patterned to form the nozzle layer 330 having a plurality of nozzles 332. In more detail, a photoresist 350 is applied on the upper surface of the nozzle plate 330′ and patterned as illustrated in FIG. 21. Accordingly, regions of the nozzle plate 330′, on which nozzles will be formed, are exposed through the patterned photoresist 350. Then, referring to FIG. 22, the nozzle plate 330′ exposed by the patterned photoresist is etched to form the nozzle layer 330 having the plurality of nozzles 332.

As described above, according to the method of manufacturing the inkjet printhead of the present general inventive concept, the chamber layer and the nozzle layer (or nozzle plate) are fabricated separately and then bonded together, thus avoiding the sacrificial layer filling process, the CMP of the sacrificial layer, and the removal of the sacrificial layer of the conventional method of manufacturing the inkjet printhead. Accordingly, the method of manufacturing the inkjet printhead can be simplified, and thus the manufacturing cost of the inkjet printhead can be reduced and productivity can be improved.

In addition, compared to the conventional nozzle layer generally formed of polymer, the nozzle layer of the present embodiment is formed of the silicon wafer or glass substrate. Therefore, damage of the nozzle layer can be prevented, and a robust inkjet printhead can be fabricated.

In addition, the ink feed hole is easily formed by the laser machining process to a constant or uniform shape. Also, the laser process is performed while the chamber layer is open, and thus the ink feed hole can be formed without damaging the structure of the inkjet printhead.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing an inkjet printhead, the method comprising:
forming an insulating layer, heaters, and electrodes sequentially on a substrate;
depositing a chamber layer having a plurality of ink chambers on the insulating layer;
forming an ink feed hole in the substrate and the insulating layer to supply ink to the ink chambers;
preparing a nozzle layer having a plurality of nozzles and an adhesive layer formed on a lower surface of the nozzle layer; and
bonding the nozzle layer to the chamber layer through the adhesive layer.

2. The method of claim 1, wherein the bonding of the nozzle layer comprises bonding the nozzle layer to the chamber layer by adhering bonding between the adhesive layer and an upper surface of the chamber layer.

3. The method of claim 1, wherein the forming of the ink feed hole comprises forming the ink feed hole through the substrate and the insulating layer by a laser machining process.

4. The method of claim 1, wherein the preparing of the nozzle layer comprises:
preparing a nozzle plate;
forming the adhesive layer on the lower surface of the nozzle plate and patterning the adhesive layer; and
etching the nozzle plate exposed by the patterned adhesive layer to form the nozzle layer having the plurality of nozzles.

5. The method of claim 4, wherein the nozzle plate is formed of a silicon wafer or a glass substrate.

6. The method of claim 1, wherein the chamber layer is formed of the same material as the adhesive layer.

7. The method of claim 1, wherein the chamber layer further includes a plurality of restrictors that connect the ink feed hole to the ink chambers.

8. The method of claim 1, further comprising:
forming a passivation layer on the heaters and the electrodes to cover the heaters and the electrodes, after forming the heaters and the electrodes.

9. The method of claim 8, further comprising:
forming anti-cavitation layers on the passivation layer that is located on the heaters, after forming the passivation layer.

10. A method of manufacturing an inkjet printhead, the method comprising:
forming an insulating layer, heaters, and electrodes sequentially on a substrate;
depositing a chamber layer having a plurality of ink chambers on the insulating layer;
forming an ink feed hole in the substrate and the insulating layer to supply ink to the ink chambers;
preparing a nozzle plate that is formed of a transparent material and includes an adhesive layer formed on a lower surface of the nozzle plate;
bonding the nozzle plate to the chamber layer through the adhesive layer;
patterning the adhesive layer; and
forming a nozzle layer having a plurality of nozzles by etching the nozzle plate exposed by the patterned adhesive layer.

11. The method of claim 10, wherein the bonding of the nozzle plate to the chamber layer comprises bonding the nozzle plate to the chamber layer by adhering bonding between the adhesive layer and an upper surface of the chamber layer.

12. The method of claim 10, wherein the forming of the ink feed hole comprises forming the ink feed hole through the substrate and the insulating layer by laser machining.

13. The method of claim 10, wherein the patterning of the adhesive layer comprises:
preparing a photo mask having nozzle patterns on an upper portion of the nozzle plate;
exposing the adhesive layer through the photo mask; and
developing the exposed adhesive layer.

14. The method of claim 10, wherein the nozzle plate is a glass substrate.

15. The method of claim 10, wherein the chamber layer is formed of the same material as the adhesive layer.

16. The method of claim 10, wherein the chamber layer further includes a plurality of restrictors that connect the ink feed hole to the ink chambers.

17. The method of claim 10, further comprising:
forming a passivation layer on the heaters and the electrodes to cover the heaters and the electrodes, after forming the heaters and the electrodes.

18. The method of claim 17, further comprising:
forming anti-cavitation layers on the passivation layer that is located on the heaters, after forming the passivation layer.

19. A method of manufacturing an inkjet printhead, the method comprising:
forming an insulating layer, heaters, and electrodes sequentially on a substrate;
depositing a chamber layer having a plurality of ink chambers on the insulating layer;
forming an ink feed hole in the substrate and the insulating layer to supply ink to the ink chambers;
preparing a nozzle plate including an adhesive layer having a shape corresponding to an upper surface of the chamber layer on a lower surface of the nozzle plate;
bonding the nozzle plate to the chamber layer through the adhesive layer; and
forming a nozzle layer having a plurality of nozzles by patterning the nozzle plate.

20. The method of claim 19, wherein bonding of the nozzle plate to the chamber layer comprises bonding the nozzle plate to the chamber layer by adhering bonding between the adhesive layer and the upper surface of the chamber layer.

21. The method of claim 19, wherein the forming of the ink feed hole comprises forming the ink feed hole through the substrate and the insulating layer by laser machining.

22. The method of claim 19, wherein the forming of the nozzle layer comprises:
applying a photoresist to an upper surface of the nozzle plate;
patterning the photoresist; and
etching the nozzle plate exposed through the patterned photoresist to form a plurality of nozzles.

23. The method of claim 19, wherein the nozzle plate is formed of a silicon wafer or a glass substrate.

24. The method of claim 19, wherein the chamber layer further includes a plurality of restrictors that connect the ink feed hole to the ink chambers.

25. The method of claim 19, further comprising:
forming a passivation layer on the heaters and the electrodes to cover the heaters and the electrodes, after forming the heaters and the electrodes.

26. The method of claim 25, further comprising:
forming anti-cavitation layers on the passivation layer that is located on the heaters, after forming the passivation layer.

27. A method of manufacturing an inkjet printhead, the method comprising:
forming an insulating layer, heaters, and electrodes sequentially on a substrate;
forming a chamber layer on the insulating layer to define a plurality of ink chambers;
forming an ink feed hole in the substrate and the insulating layer to supply ink to the ink chambers; and
bonding a nozzle layer to the chamber layer to through the adhesive layer.

28. The method of claim 27, wherein the ink feed hole is formed before the bonding the nozzle layer to the chamber layer.

29. The method of claim 27, wherein the bonding of the nozzle layer to the chamber layer comprises forming an adhesive layer on between the nozzle layer and the chamber layer, and attaching the bonding layer to the chamber layer.

30. The method of claim 27, wherein the bonding of the nozzle layer to the chamber layer comprises forming a plurality of nozzles to correspond to the respective ink chambers in the nozzle layer before or after the bonding of the nozzle layer to the chamber layer.

31. The method of claim 27, wherein the bonding of the nozzle layer to the chamber layer comprises forming an adhesive layer on between the nozzle layer and the chamber layer, and attaching the bonding layer to the chamber layer, forming regions to correspond to nozzles on the adhesive layer, and forming the nozzles to correspond to the respective ink chambers on the nozzle layer through the regions of the adhesive layer before or after the bonding of the nozzle layer to the chamber layer.
